(19) United States
(12) Patent Application Publication
(10) Pub. No.: US 2009/0216827 A1
(43) Pub. Date: Aug. 27, 2009

(54) Virtual Sensor

(75) Inventors: Yoshiya Hirase, Tokyo (JP); Eigo Mori, Saitama (JP); Hiroo Ishikawa, Toky (JP)

Correspondence Address: HARRINGTON & SMITH, PC, 4 RESEARCH DRIVE, Suite 202, SHELTON, CT, 06484-6212, US

(73) Assignee: NOKIA CORPORATION, Espoo (FI)

(21) Appl. No.: 11/922,465

(22) PCT Filed: Jun. 21, 2006
(86) PCT No.: PCT/IB2006/051996

§ 371 Date: Jan. 29, 2009

(30) Foreign Application Priority Data
Jun. 24, 2005 (JP) 2005-185740

(51) Int. Cl. G06F 15/16; G06F 9/54

(52) U.S. Cl. 709/201; 719/313; 709/217; 710/260

(57) ABSTRACT

The object of the present invention is to enable to utilize the sensor(s) in the manner that is optimized for the application, as well as easily. According to one aspect of the present invention, the invention provides a computer software configured to receive instructions from another software, collect information from one or a plurality of sensors based on said instructions, determine whether said information satisfies the conditions required by said instruction, and if so, report to that effect to said other software.

The present invention relates to a method for utilizing a sensor in an electronic device having a sensor.

Recently, various endeavors are being made to develop new applications by deploying sensors in portable electronic devices, such as cellular phones. As an example of a sensor deployed in a cellular phone and the utilization thereof, cellular phones that are, for example, equipped with an acceleration sensor and interprets the user's movement as operation instructions, are commercially available. In addition, other utilizations have been developed, such as deployment of a light sensor for brightness control, or deployment of an RFID sensor for use in payment transactions. Additionally, electronic devices equipped with a barometer or a hygrometer to forecast the weather from changes in barometric pressure or humidity are also commercially available.

However, a sensor may not always be optimized for the existing application software that uses the sensor. Actually, most sensor devices tend to be either overly idle, or overly active. For example, a certain type of sensor sends data only upon receipt of a direct query from the application software, thus the application must constantly monitor the sensor. Another type of sensor continuously sends data needlessly.

In addition, it may be difficult to incorporate the programming code for sensor control into the application software, especially when there is a need to control a plurality of sensors. Therefore, a scheme has been sought to enable the use of a sensor that is both optimized for the application, as well as easier to use than ever before.

The object of the present invention is to enable to utilize the sensor(s) in the manner that is optimized for the application, as well as easily.

According to one aspect of the present invention, the invention provides the following computer software, i.e. program. This software is a program configured to receive an instruction from another software, collect information from one or a plurality of sensors based on said instruction, judge whether said information satisfies the condition required from said instruction, and if so, report to said another software.

According to said software which provided by the present invention, since this software takes charge of collecting and analyzing the information from sensors, the other software employing said software can minimize the programming code required to control the sensors. In other words, by employing said software, the programming efforts required for utilizing the sensor can be greatly reduced. As the number of sensors being used increases, the benefits become greater.

In addition, the condition required by the instruction from the other software using said software according to the present invention can be made such that it relates to the conditions of the plurality of sensors. In other words, the other software using said provided software can define a virtual sensor containing the combined information on a plurality of sensors. Thereby, said provided software appears to operate as a virtual sensor for the other software. In this manner, said provided software enables the use of the sensor that is optimized for the requirements and operation of the application, as well as easier to use.

Preferably, said instruction is software function. Additionally, said instruction can consist of a combination of a plurality of software functions. Thus, said software according to the present invention is preferably programmed to interpret the software functions, collect information directly from the sensor(s) based on the results of the interpretation, and analyze the collected information.

Said software provided by the present invention is preferably programmed to receive and process a plurality of instructions from one or two or more other programs.

Said software provided by the present invention is preferably configured to perform said reporting to the other software through an interrupt request.

In one embodiment, the software according to the present invention can be configured to control not only sensors incorporated in an electronic device on which said software is installed, but also to control other remote sensors. For example, the software according to the present invention can be configured to control a sensor connected to said electronic device by a wireless communication means such as a cellular network, Bluetooth, UWB and WLAN, or a sensor connected over the Internet. According to this embodiment, the other software employing the software according to the present invention can use these sensors without concern for the physical location of the sensors. Of course, a virtual sensor combining a plurality of remote sensors can also be defined.

The software according to the present invention can be installed on a portable electronic device such as a cellular phone. In addition, the software according to the present invention can also be stored on a memory media such as a CD, produced and marketed, or distributed, for example, via the Internet or a cellular network.

According to another aspect of the present invention, the invention provides the following electronic device: the electronic device comprising a sensor, a first software, and a second software operating between said sensor and said first software, wherein said second software is configured to receive an instruction from said first software, collect information from said one or a plurality of sensors based on said instruction, and report to said first program based on said collected information.

Said electronic device may comprise a plurality of sensors controllable by the second software. In addition, the first software is preferably configured to receive an interrupt request from the second software, and the second software is preferably configured to perform the above-mentioned reporting according to the interrupt request. In addition, said second software is preferably configured to collect information on sensors remote from the body of the electronic device.

Said provided electronic device is preferably a portable information device.

Using the present invention, the use of a sensor that is both optimized for the application, as well as easier to use can be provided.

The embodiments of the present invention are explained hereinafter by way of examples and with reference to the drawings, which is:

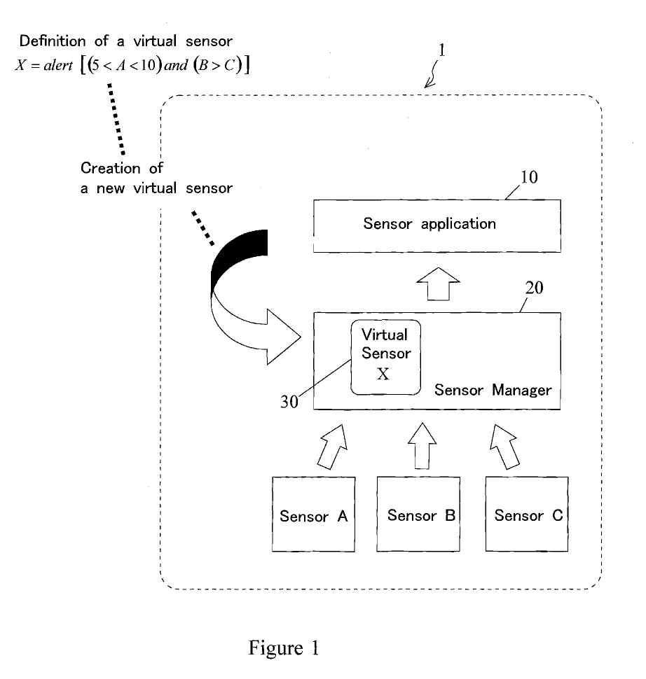

FIG. 1 is a schematic diagram illustrating an embodiment of the present invention.

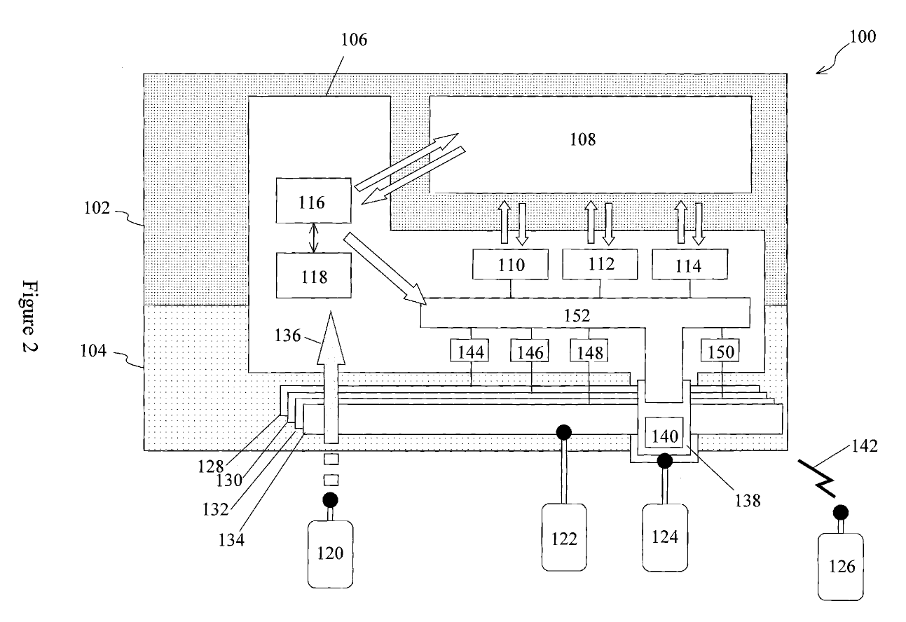

FIG. 2 is a schematic diagram illustrating another embodiment of the present invention.

An electronic device 1, to which the present invention is applied, comprises sensor application 10, sensor manager 20, sensor A, sensor B, and sensor C. The sensor application 10 is software that provides to the user various features through use of the sensor, such as weather forecasting or other operations of the electronic device 1. The sensor manager 20 is software operating between the physical sensors A, B and C and the sensor application 10. The sensor manager 20 collects information from the sensor A, sensor B, and so on based on the instructions from sensor application 10, analyzes the information, and reports the results to the sensor application 10. The sensor application 10 and sensor manager 20 actualize the above-mentioned features, as well as the features described below, by operating CPU (not shown) that is comprised in the electronic device 1 according to instructions in the software.

Instructions sent from the sensor application 10 to the sensor manager 20 are in the form of software functions. Therefore, the sensor manager 20 is programmed to understand and execute the contents of these functions. The instructions sent from the sensor application 10 to the sensor manager 20 may consist of a combination of a plurality of software functions.

Furthermore, the instructions sent from the sensor application 10 to the sensor manager 20 may relate to the conditions of one or a plurality of sensor A, sensor B and sensor C. In other words, said instructions include features that are similar to those of a virtual “new” sensor composed of all three of sensors A, B and C.

In FIG. 1, the sensor application 10 defines the following virtual sensor X as instructions to the sensor manager 20 and sends said instructions to the sensor manager 20.

X=alert [(5<A<10)and (B>C)] (1)

The “alert” function is a function for making reports when the conditions contained in parentheses have been satisfied. The sensor manager 20, which has received said instructions, collects information from the sensors A to C, analyzes whether the sensors satisfy the conditions required by the instructions, and if so, reports said conditions to the sensor application 10. In other words, when the sensor manager 20 detects conditions in which the output value of the sensor A is between 5 and 10 and the output value of the sensor B is larger than that of the sensor C, it reports the conditions to the sensor application 10. In this manner, the “alert” function acts like a virtual sensor to detect the conditions defined by Equation 1. Since the sensor application 10 does not have to collect information from the sensors A to C or contain the programming code required to analyze whether said information satisfies Equation 1, the programming work for the sensor application can be very efficient. The “alert” function and Equation 1 are of course only examples, and various types of functions can be defined between the sensor application 10 and the sensor manager 20.

When detecting the conditions defined by Equation 1, the sensor manager 20 reports said conditions to the sensor application 10 through an interrupt request. Of course, the sensor application 10 should also be programmed to receive the interrupt request from the sensor manager 20. The interrupt request is an existing technology and can be implemented by one skilled in the art. Using this configuration, the sensor application 10 does not have to be programmed to check the sensor output values regularly. In this way, the present invention enables to utilize the sensor(s) in the manner that is optimized for the application, and further, easily.

As a more specific example, the electronic device 1 can be configured as a “laundry sensor”. In this example, the sensor A is a temperature sensor and the sensor B is a humidity sensor. The sensor C will not be necessary. The sensor application 10 defines a virtual sensor that receives a report when certain conditions are satisfied in the relationship between temperature and humidity, and sends a command to the sensor manager 20. This relationship is preferably one in which the user can specify his/her own settings in addition to the predetermined settings. The sensor application 10, based on the report from the sensor manager 20, transmits a message such as “Today is a good day for hang-drying clothes,” to the user through, for example, audio or visual means. The sensor manager 20 regularly checks the output values from the temperature sensor and humidity sensor to determine whether the values satisfy the defined conditions. However, the sensor application 10 does not have to perform such an operation and only reports to the user based on the report from the sensor manager 20. Therefore, the structure of the sensor application 10 can be greatly simplified.

As another specific example, electronic device 1 can be configured as a “weather sensor”. In this example, the sensor A is a temperature sensor, the sensor B is a humidity sensor, and the sensor C is a barometric pressure sensor. The sensor application 10 defines a virtual sensor that receives a report, such as “fair” “cloudy” or “rainy” based on changes in the temperature, humidity, and barometric pressure. The sensor manager 20 checks these three output values regularly (for example, at 30-second intervals) and calculates the rate of change of said output values. Then, based on the rate of change, the sensor manager 20 determines forecasts such as, for example, “It will clear up,” “It will be cloudy in the afternoon” or “It will rain tomorrow.” The sensor application 10 receives a report of the weather forecast from the sensor manager 20, for example, once every hour, and based on said report, the sensor application 10 forecasts the weather for the user by, for example, visual or audio means. The sensor application 10 does not have to contain any programming code for sensor control or analysis, greatly reducing the programming effort required compared to cases in which the present invention is not applied.

In another embodiment, the sensor manager 20 can also be configured to control sensors remote from the body of the electronic device 1. For example, the sensor manager 20 can be configured to control a sensor connected to the electronic device 1 by wireless communication means such as cellular network, Bluetooth, UWB and WLAN, or a sensor connected over the Internet. Even in such an embodiment, the sensor application 10 can define a virtual sensor without particular regard to the physical location of the sensors. Of course, a virtual sensor combining a plurality of remote sensors can also be defined.

The electronic device 1 may be a sensor application-specialized device, a cellular phone, PDA, or the like. In addition, an embodiment is also possible wherein various sensor applications are installed in a portable electronic device pre-equipped with a physical sensor and sensor manager.

Next, another embodiment of the present invention is explained by reference to FIG. 2. System 100 of this example has an OS (operating system) comprising a user space 102 and a kernel space 104. A sensor manager 106 having the same features as the sensor manager 20, i.e., collects information from the sensors based on instructions from a sensor application-108 having the same features as the sensor application 10, analyzes the information, and reports the results to the sensor application 108. The sensor application 106 and the sensor application 108 have more advanced features than the sensor manager 20 and the sensor application 10. The instructions from the sensor application 108, similarly to the instructions defined by the sensor application 10, have the features of a virtual sensor combining a plurality of sensors. The sensor application 108 defines a plurality of virtual sensors 110, 112 and 114, and the sensor manager 106 can process these virtual sensors 110, 112 and 114 in parallel. The virtual sensors transmit from the sensor application 108 to the sensor manager 106 via a software interface 116. In addition, the sensor information handled by the sensor manager 106 is transmitted from the sensor information storage 118 to the sensor application 108 via the software interface 116.

Sensors 120, 122, 124 and 126 are physical sensors. The sensors are connected to the sensor manager 106 through device drivers 128, 130, 132, 134 or the like. Sensor 120 is detected by and connected to the sensor manager 106 through the dynamic detection method.

The sensor 122 is connected to the sensor manager 106 through the device driver 134. The sensor 124 is connected to the sensor manager 106 through a sensor entry 140 of FPGA 138. The sensor 126 is connected to the sensor manager 106 by a wireless communication means 142.

The sensors connected to the device drivers are connected to a sensor virtualization block 152 of the sensor manager 106 through sensor entries 144, 146, 148, 150 or the like. The sensor virtualization block 152 can filter the sensor output data and combine a plurality of sensor output.

Although the embodiments of the present invention were explained by way of the above examples, it goes without saying that the embodiments of the invention are not limited to these examples and various modifications may be made without departing from the spirit and scope of the invention.

1. A computer program, wherein said program is configured to receive an instruction comprising one or plurality of software functions from another computer program, collect information from one or a plurality of sensors based on said instruction, and report to said another program based on said collected information.

2. A computer program according to claim 1, wherein said program is configured to judge whether said information satisfies a condition defined by said instruction, and if so, report to said another program.

3. A computer program according to claim 1, wherein said condition defined by said instruction relates to conditions of a plurality of sensors.

4. A computer program according to claim 1, wherein said program is configured to make said report by issuing an interrupt request to said another program.

5. A computer program according to claim 1, wherein said program is configured to process a plurality of said instructions in parallel.

6. A computer program according to claim 1, wherein said program comprises a means for collecting information from the sensors through a wireless communication means.

7. A computer program according to claim 1, wherein said program comprises a means for collecting information from the sensors over the Internet.

8. (canceled)

9. (canceled)

10. (canceled)

11. A sensor system comprising an electronic device and a plurality of physical sensors, where:
the electronic device further comprising a CPU, a first computer program, a second computer program that is a different computer program with the first computer program and works between the plurality of physical sensors and the first computer program,
the first computer program being arranged to operate the CPU to provide an instruction comprised by software function to the second computer program, and
the second computer program being arranged to operate the CPU to collect information from at least one of the physical sensors, to make an analysis for the collected information based on the instruction, and to inform a result of the analysis to the first computer program.

12. A sensor system according to claim 11, where the first computer program being arranged to operate CPU to make a notification to a user of the sensor system based on the informed result of the analysis.

13. A sensor system according to claim 12, where the first computer program is arranged to allow a software interruption by the second computer program, and the second computer program is arranged to inform the result of the analysis to the first computer program by the software interruption to the first computer program.

14. A sensor system according to claim 11, where all of the physical sensors are integrated in the electronic device.

15. A sensor system according to claim 11, where at least one of the physical sensors is a separate device from the electronic device, that is connected with the electronic device by a wireless communication means.

16. A sensor system according to claim 11, where at least one of the physical sensors is connected to the electronic device through a FPGA of the electronic device.

17. A sensor system according to claim 11, where at least one of the physical sensors is connected to the electronic device via active sensor detection means of the electronic device.

18. A computer program working as the first computer program of the electronic device in a sensor system according to claim 11, the computer program being arranged to instruct a CPU of the electronic device to provide an instruction basing a function using output values of the physical sensors as variables, to an other computer program of the electronic device.

19. A computer program working as the second computer program of the electronic device in a sensor system according to claim 11, the computer program being arranged to instruct a CPU of the electronic device: to collect information from physical sensors based on an instruction comprised by a software function; to make an analysis for the collected information based on the instruction; and to inform a result of the analysis to an other computer program of the electronic device.

20. A sensor system comprising
a first wireless communication apparatus being enabled to communicate with other apparatus by a first wireless communication system and having a first physical sensor,
a second wireless communication apparatus being enabled to communicate with other apparatus by a second wireless communication system and having a second physical sensor,
a third wireless communication apparatus being able to communicate with the first wireless communication apparatus by the first wireless communication system, and to communicate with the second wireless communication apparatus by the second wireless communications system,
where
the third wireless communication apparatus comprising a CPU, a first computer program and a second computer program which is different from the first computer program,
the first computer program is arranged to instruct the CPU to provide an instruction basing a function using a measurement value of the first physical sensor and a measurement value of the second physical sensor as variables, to the second computer program,
the second computer program is arranged to instruct the CPU to obtain, in response to a receipt of the instruction of the first computer program, measurement values of the first and second physical sensors; to check whether the obtained measurement values satisfy the conditions indicated in the instruction or not; and if satisfy, to inform to the first computer program about the satisfaction.

21. A sensor system according to claim 20, where both the first and the second wireless communications systems are the cellular system.

22. A sensor system according to claim 20, where the first wireless communications system is the cellular system, and the second wireless communication system is one of the Bluetooth, UWB, and WLAN.

23. A sensor system according to claim 20, where both the first and the second wireless communications systems are one of the Bluetooth, UWB, and WLAN.

24. A sensor system according to claim 20, where at least one of the first and the second wireless communication apparatuses is connected to the third wireless communication apparatus via Internet.

25. A sensor system according to claim 20, where the first computer program is arranged to allow a software interruption by the second computer program, and the second computer program is arranged to inform the result of the analysis to the first computer program by the software interruption to the first computer program.

26. A computer program working as the first computer program of the third wireless communication apparatus in a sensor system according to claim 20, the computer program being arranged to instruct a CPU of the third wireless communication apparatus to provide an instruction basing a function using measurement values of the first and the second physical sensors as variables, to an other computer program of the third wireless communication apparatus.

27. A computer program working as the second computer program of the third wireless communication apparatus in a sensor system according to claim 20, the computer program being arranged to instruct a CPU of the third wireless communication apparatus: to obtain measurement values of the first and the second physical sensors in response to receive an instruction basing a function using measurement values of the first and the second physical sensors as variables; to check to check whether the obtained measurement values satisfy the conditions indicated in the instruction or not; and if satisfy, to inform an other computer program of the third wireless communication apparatus about the satisfaction.
